(19) United States
(12) Patent Application Publication
(10) Pub. No.: US 2015/0017367 A1
(43) Pub. Date: Jan. 15, 2015

(54) BIOPLASTIC COMPOSITIONS AND RELATED METHODS

(71) Applicant: ECOSPAN USA, Greenbrae, CA (US)

(72) Inventor: Scott Sanderson, Chester Springs, PA (US)

(21) Appl. No.: 14/375,820

(22) PCT Filed: Feb. 1, 2013
(86) PCT No.: PCT/US13/24487

§ 371 Date: Jul. 31, 2014

Related U.S. Application Data
(60) Provisional application No. 61/594,638, filed on Feb. 3, 2012.

(51) Int. Cl. C08L 67/04; B65D 43/16

(52) U.S. Cl. CPC C08L 67/04; B65D 43/162; C08L 2205/025; C08L 2205/06
USPC 428/36.92; 524/445; 428/156

(57) ABSTRACT

Bioplastic compositions having favorable mechanical and molding characteristics. Methods of forming these compositions and also workpieces formed from these compositions. The compositions comprising a polylactic acid; a polyhydroxyalkanoate; a plurality of clay particles; a plurality of talc particles; and a modifier capable of facilitating mixing between the clay particles and the talc particles. The compositions suitably include a polylactic acid, a polyhydroxyalkanoate, a plurality of clay particles, a plurality of talc particles. The compositions also suitably include a modifier capable of facilitating mixing between the clay particles and the talc particles. The clay particles may have an average diameter in the range of from about 2 nm to about 100 nm; a diameter of 8 nm is considered suitable.

### TECHNICAL FIELD

The present invention relates to the field of bioplastic compositions. The present invention also relates to the field of incorporating particulate materials into biopolymers.

### BACKGROUND

Bioplastic materials, such as those made from naturally-derived polymers, have attracted interest as of late. The ability to fabricate such materials from sustainable sources makes the materials attractive, but bioplastics have historically exhibited mechanical properties (e.g., brittleness, low resistance to fatigue) that renders them unsuitable for certain applications, such as living hinges. Accordingly, there is a need in the field for bioplastic compositions having improved mechanical properties.

### SUMMARY

In meeting the disclosed challenges, disclosed here are first compositions, the compositions comprising a polylactic acid; a polyhydroxyalkanoate; a plurality of clay particles; a plurality of talc particles; and a modifier capable of facilitating mixing between the clay particles and the talc particles.

Also provided are workpieces. The workpieces suitably comprise first and second sections being connected by a living hinge formed by a composition according to the present disclosure.

The present disclosure also provides processes. These processes suitably include molding a bioplastic composition at a meltflow value of from about 45 to about 80; the bioplastic is suitably a composition according to the present disclosure.

Also provided are containers, the containers suitably including a portion comprising a composition according to the present disclosure. The containers suitably include a living hinge comprising a composition according to the present disclosure.

This disclosure also provides methods. These methods include blending a polylactic acid; a polyhydroxyalkanoate; a plurality of clay particles; a plurality of talc particles; and a modifier capable of facilitating mixing between the clay particles and the talc particles.

### BRIEF DESCRIPTION OF THE DRAWINGS

The summary, as well as the following detailed description, is further understood when read in conjunction with the appended drawings. For the purpose of illustrating the disclosure, there are shown in the drawings exemplary embodiments of the disclosure; however, the disclosure is not limited to the specific methods, compositions, and devices disclosed. In addition, the drawings are not necessarily drawn to scale. In the drawings:

FIG. 1 depicts a side view of a package formed from a composition according to the present disclosure, wherein the package includes a living hinge formed from the disclosed composition;

FIG. 2 depicts a view of the interior of the package shown in FIG. 1, with the living hinge in an opened position;

FIG. 3 depicts a view of the package of FIGS. 1 and 2, with the living hinge in a closed position;

FIG. 4 depicts a side view of the package of FIG. 3, with the living hinge in a closed position; and

FIG. 5 illustrates the package of FIGS. 1-4, including non-limiting dimensions for the various portions of the package.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claims. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. Any documents cited herein are incorporated herein by reference in their entireties for any and all purposes.

In a first aspect, the present disclosure provides compositions. The compositions suitably include a polylactic acid (available from, e.g., Natureworks), a polyhydroxyalkanoate (available from, e.g., Metabolix, Tepha, Greenbio, PHB Industrial SA), a plurality of clay particles, a plurality of talc particles. The compositions also suitably include a modifier capable of facilitating mixing between the clay particles and the talc particles.

The clay particles may have an average diameter in the range of from about 2 nm to about 100 nm; a diameter of 8 nm is considered especially suitable. Clays from Thailand are considered especially suitable. Without being bound to any particular theory, the presence of clay allows one to impart a lubricity to the composition that assists in releasing the composition from a mold without having to add a release agent. The clay may also confer strength, stretch, ductility, elasticity, or any of the foregoing onto the composition.

Talc particles may be purchased commercially. Talc particles may have a size in the range of from 2 nm up to 10, 20, or even 50 micrometers. Talc particles having a diameter in the range of from about 50 nm to about 150 nm are especially suitable.

The modifier may be one or more chemical components or compositions that acts to bring the clay and the talc together so as to form an integrated composition and to prevent the formation of layers that may in turn delaminate. Suitable modifiers include block copolymers, graft copolymers and crosslinking peroxides. Suitable graft copolymers can be selected from the Modiper™ A series from the NOF Corporation in Japan, which can be selected from one or more of the following:

| CODE | COMPOSITION | (wt %) | CAS NO. |
|---|---|---|---|
| MODIPER ™ A1100 | LDPE-graft-PS | 70/30 | 106826-12-4 |
| MODIPER ™ A4100 | E/GMA-graft-PS | 70/30 | 117091-81-3 |
| MODIPER ™ A4300 | E/GMA-graft- | 70/30 | 118497-17-9 |
| | P(BA/MMA) | | |
| MODIPER ™ A5300 | E/EA-graft-P(BA/MMA) | 70/30 | 118497-18-0 |
| MODIPER ™ A1401 | LDPE-graft-PSAN | 50/50 | 106826-13-5 |
| MODIPER ™ A3400 | PP-graft-PSAN | 70/30 | 115180-57-9 |
| MODIPER ™ A4400 | E/GMA-graft-PSAN | 70/30 | 118497-09-9 |
| MODIPER ™ A5400 | E/EA-graft-PSAN | 70/30 | 118497-12-4 |
| MODIPER ™ A8400 | E/EA/MAH-graft-PSAN | 70/30 | 135720-40-4 |
| MODIPER ™ A6600 | E/VA-graft-mPMMA | — | — |

E/GMA: Poly(ethylene-stat-glycidyl methacrylate), (85/15 wt %)
E/EA: Poly(ethylene-stat-ethyl acrylate), (80/20 wt %)
E/VA: Poly(ethylene-stat-vinyl acetate), (85/15 wt %)
E/EA/MAH: Poly(ethylene-stat-ethyl acrylate-stat-maleic anhydride), (85/12/3 wt %)
PSAN: Poly(styrene-stat-acrylonitrile), (70/30 wt %)
mPMMA: modified PMMA

Suitable block copolymers include any of the styrene block copolymers as well as acrylic block copolymers. Examples of styrene block copolymers include the Kraton™ G SEBS and SEPS polymers, such as the styrene-ethylene-propylene block types, available from Kraton Performance Polymers, Inc.

Suitable crosslinking peroxides are commercially available from AkzoNobel under the Perkadox™ trade name. Suitable Perkadox™ crosslinking peroxides can include one or more of the following:

| Crosslinking Peroxide | Chemical Description |
|---|---|
| PERKADOX 14-40A-GR | Di(tert-butylperoxyisopropyl)benzene, |
| | granules, 40% with EVA |
| PERKADOX 14-40B-GR- | Di(tert-butylperoxyisopropyl)benzene, |
| DD | granules, 40% with calcium carbonate |
| | and silica |
| PERKADOX 14-40B-PD | Di(tert-butylperoxyisopropyl)benzene, |
| | powder, 40% with calcium carbonate |
| | and silica |
| PERKADOX 14-40K-PD | Di(tert-butylperoxyisopropyl)benzene, |
| | powder, 40% with clay and silica |
| PERKADOX 14-40MB-GR | Di(tert-butylperoxyisopropyl)benzene, |
| | granules, 40% with calcium carbonate, |
| | silica and EPDM |
| PERKADOX 14S | Di(tert-butylperoxyisopropyl)benzene, |
| | crystalline |
| PERKADOX 14S-FL | Di(tert-butylperoxyisopropyl)benzene, |
| | flakes |
| PERKADOX BC-40B-PD | Dicumyl peroxide, powder, 40% |
| | with calcium carbonate |
| PERKADOX BC-40K-PD | Dicumyl peroxide, powder, 40% with clay |
| PERKADOX BC-40MB-GR | Dicumyl peroxide, granules, 40% |
| | with calcium carbonate, silica and EPDM |
| PERKADOX BC-40P-PD | Dicumyl peroxide; powder; 40% |
| | with LDPE, calcium carbonate and silica |
| PERKADOX BC-FF | Dicumyl peroxide, crystalline |
| PERKADOX BTW-55 | Dibenzoyl peroxide, paste, 55% |
| | in solvent mixture |

The one or more modifiers may be present at a weight percentage of from about 1 to about 99%, from about 2 to about 50%, or even from about 3 to about 5%.

The polylactic acid (PLA) of the disclosed compositions may be amorphous or crystalline; crystalline polylactic acid is considered especially suitable. Exemplary polylactic acid may be purchased from Natureworks or other commercial vendors.

The polyhydroxyalkanoate (PHA) may be amphorhous or crystalline; crystalline polyhydroxyalkonate is considered especially suitable. PLA may be present in a wt % of from about 5% to about 85%, or from about 15% to about 75%, with 60% being especially suitable.

PHA may be present in a wt % in the range of from about 10% to about 90%, or from about 20% from about 80%, or even from about 40% to about 60%. Clay may be present in the range of from about 1 wt % to about 50 wt %, or even from about 2 wt % to about 10 wt %. Talc may be present in the range of from about 1 wt % to about 50 wt %, or from 5 wt % to about 10 wt % or about 20 wt %. The modifier is suitably present in the range of from about 0 wt % to about 15% or about 20 wt %, with 5 wt % being especially suitable.

The compositions may be characterized as having a heat distortion temperature of greater than about 60° C., about 70° C., or even higher than about 80° C. or even higher than about 90° C.

The compositions may include other additives. Such additives include, e.g., colorants, antimicrobials, metals, TiO2, TAIC cross linking agent, Trigonox 301 and Stabiol P, and the like. Other cross-linkers, stabilizers, fire retardants, plasticizers, and the like may be added. Some additives may act to marry talc and clay to the other materials. A crosslinker may be used to bind the talc and clay to the PLA, PHA, or both. In some embodiments, the user may bind clay and talc to one another and then mix the clay/talc with the PLA, PHA, or both. Nanoparticles (e.g., having a cross-sectional dimension in the range of from about 1 nm to about 1000 nm) of any composition may be incorporated into the disclosed compositions. Silver, gold, and carbon nanoparticles are all considered suitable for this application. Carbon nanotubes (single-wall and multi-wall) may also be incorporated into the disclosed compositions. Additives (e.g., nanoparticles) may be present at from about 0.00001 wt % to about 50 wt %, or from about 0.1 wt % to about 10 wt %, or even at about 5 wt %.

Unless indicated otherwise, as used herein throughout the specification, “wt %” generally refers to weight percent based on total weight of the composition.

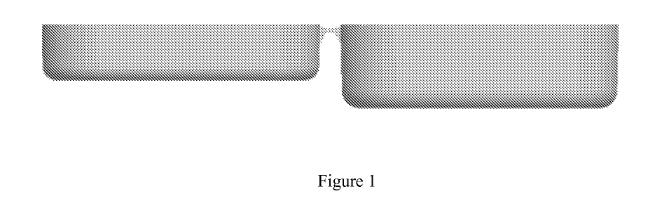

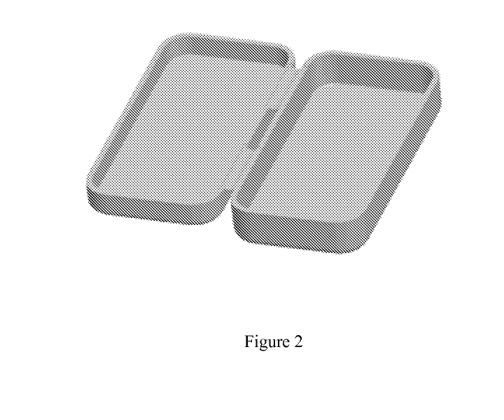

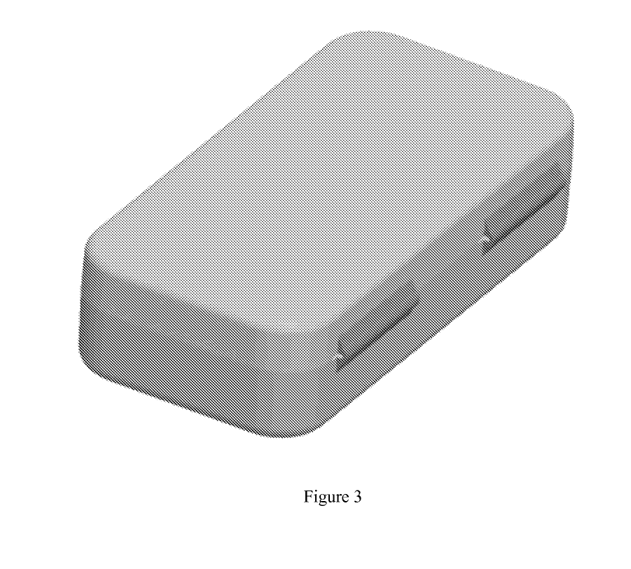

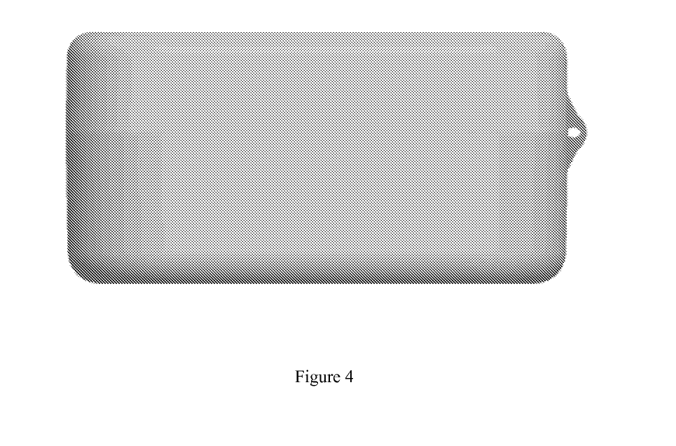

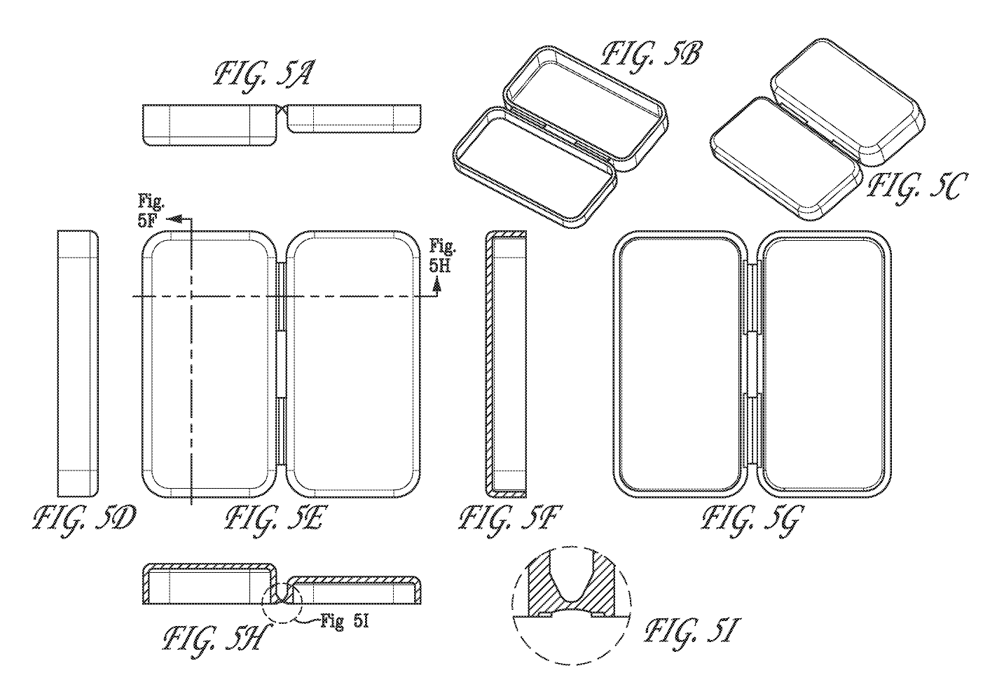

Also provided are workpieces. The workpieces suitably include a first section and a second section, the first and second sections being connected by a living hinge formed of a composition according to the present disclosure. The first and second sections of the workpiece may comprise a composition according to the present disclosure. In some embodiments, the workpiece is a container formed from a composition according to the present disclosure. One such exemplary container is shown by FIGS. 1-5. In some embodiments, the entire container is formed from the disclosed compositions.

Also provided are methods. The methods include molding a bioplastic composition at a meltflow value of about 45 to about 80, the bioplastic suitably being a composition according to the present disclosure. Such meltflow values allow the user to form—thin walls, complex molds, different thicknesses in different parts of a mold, and even allow dense material packing into a mold. Such meltflow values also allow a user to work with higher-pressure molding than other existing bioplastic materials. The disclosed materials are also capable of supporting a finish, sheen, or color that is not supported by existing bioplastic materials.

The disclosed materials also permit comparatively low temperature processing. The processing temperatures may be 10, 20, or even 25 or 30% lower than the processing temperatures for comparable petroleum-based plastic materials. As a consequence, lower molding temperatures allow for faster cooling in molds.

In traditional processes, molds are run at comparatively hot temperatures. By comparison, the disclosed materials pack densely into molds. Because cooling times contribute to overall cycle times, one may cool the mold (e.g., by a radiator-type structure, or even by a cooling jacket). A mold may be run at only about 30° C., about 35° C., or even about 40° C. for the disclosed materials, whereas molds for traditional polypropylene may be run at 45° C.

Items formed from the disclosed compositions may be subject to an annealing process. A part may be taken out of a mold and then placed onto a sister mold (skeleton mold). Thus process may, without being bound to any single theory, this may help to align the microstructure of the parts.

Demolding may be accomplished by application of air pressure. For example, air may be exerted through an aperture in a mold so as to de-mold an item. Such an aperture may even be constructed so that it lies behind a door, slider, or other portion of the mold in order that the aperture is shielded from the molded part during molding and then, once molding is complete, a slider or door moves to reveal the aperture and air may be exerted through the aperture to force the part out of the mold.

A user may form the disclosed compositions into a variety of configurations. Containers, shells, packages, and the like are all suitable forms. Electronics components and food packaging are considered especially suitable, as are other retail packaging.

What is claimed:

1. A composition, comprising:
a polylactic acid;
a polyhydroxyalkanoate;
a plurality of clay particles;
a plurality of talc particles; and
a modifier capable of facilitating mixing between the clay particles and the talc particles.

2. The composition of claim 1, wherein the polylactic acid comprises crystalline polylactic acid, amorphous polylactic acid, or both.

3. The composition of claim 1, wherein the polyhydroxyalkanoate comprises crystalline polyhydroxyalkanoate, amorphous polyhydroxyalkanoate, or both.

4. The composition of claim 1, wherein the composition is characterized as having a heat distortion temperature of greater than about 80° C.

5. The composition of claim 4, wherein the composition is characterized as having a heat distortion temperature of greater than about 90° C.

6. The composition of claim 1, wherein a clay particle has an average diameter in the range of from about 2 nm to about 100 nm;

7. The composition of claim 1, wherein a talc particle has an average diameter in the range of from about 2 nm up to about 50 micrometers.

8. The composition of claim 1, further comprising TiO2, a colorant, TAIC cross linking agent, Trigonox 301, Stabaol P, a cross-linker, a stabilizer, a lubricant, or any combination thereof.

9. The composition of claim 1, wherein the polylactic acid is present in a wt % of from about 5% to about 85%.

10. The composition of claim 1, wherein the polyhydroxyalkanoate is present in a wt % in the range of from about 10% to about 90%.

11. The composition of claim 1, wherein the clay is present in the range of from about 1 wt % to about 50 wt %.

12. The composition of claim 1, wherein the talc is present in the range of from about 1 wt % to about 50 wt %

13. The composition of claim 1, wherein the modifier is suitably present in the range of from about 0 wt % to about 20 wt %.

14. A workpiece, comprising:
first and second sections being connected by a living hinge formed by a composition according to claim 1.

15. The container of claim 14, wherein at least one of the first and second sections is formed from the composition according to claim 1.

16. A process, comprising:
molding a bioplastic composition at a meltflow value of from about 45 to about 80.

17. The process of claim 16, wherein the bioplastic composition is a composition according to claim 1.

18. A container, comprising:
A portion comprising a composition according to claim 1.

19. The container of claim 18, further comprising a living hinge comprising a composition according to claim 1.

20. A method, comprising:
blending a polylactic acid;
a polyhydroxyalkanoate;
a plurality of clay particles;
a plurality of talc particles; and
a modifier capable of facilitating mixing between the clay particles and the talc particles.

21. The method of claim 20, further comprising blending the clay particles and the talc particles to form a first admixture, and mixing the first admixture with the polylactic acid, the polyhydroxyalkanoate, or both.

22. The composition of claim 1, further comprising a population of nanoparticles.

23. The composition of claim 22, wherein the population of nanoparticles is present at from about 0.00001 wt % to about 10 wt %
